(19) United States
(12) Patent Application Publication
(10) Pub. No.: US 2022/0202032 A1
(43) Pub. Date: Jun. 30, 2022

(54) A PROCESS OF PRODUCING A GREEN LEAF TEA PRODUCT

(71) Applicants: Conopco, Inc., d/b/a UNILEVER, Englewood Cliffs, NJ (US); UNILEVER IP HOLDINGS B.V., Rotterdam (NL)

(72) Inventors: Ajit BHASKAR, Bangalore (IN); Debjani GHOSH, Jalpaigur (IN); Vadivel GOVINDASWAMY, Vellore District (IN); Sreeramulu GUTTAPADU, Bangalore (IN); Deepak Ramachandra MHASAVADE, Karntataka (IN)

(21) Appl. No.: 17/439,274

(22) PCT Filed: Mar. 5, 2020
(86) PCT No.: PCT/EP2020/055760

§ 371 Date: Sep. 14, 2021

(30) Foreign Application Priority Data
Mar. 15, 2019 (EP) 19163225.6

(51) Int. Cl. A23F 3/06

(52) U.S. Cl. CPC A23F 3/06

(57) ABSTRACT

The present invention relates to a process of producing a green leaf tea. More particularly the present invention relates to a process of producing a green leaf tea with higher soluble solids and unique aroma characteristics. Accordingly, the present invention provides a process of preparation of green leaf tea product comprising the steps of: a. incubating fresh tea leaf at a temperature in the range 4° C. to 80° C. under anaerobic conditions for a period of 4 to 72 hours; b. subjecting the incubated leaf to a step of thermal treatment at a temperature in the range of 60° C. to 250° C. for about 15 seconds to 60 minutes; c. drying the leaf to a moisture content less than 8% by total mass of the tea leaf to obtain a green leaf tea.

### FIELD OF THE INVENTION

The present invention relates to a process of producing a green leaf tea. More particularly the present invention relates to a process of producing a green leaf tea with higher soluble solids and unique aroma characteristics.

### BACKGROUND OF THE INVENTION

Tea is one of the most popular beverages in the world. It is believed that consumption of tea refreshes our mind. Polyphenols that are present in tea are also considered to be good for human health. There are varieties of tea available in the market, e.g. black tea, green tea, oolong tea, white tea, etc. Black tea is generally prepared by a process which includes the steps of withering, macerating, fermenting and firing/drying. On the other hand, green tea manufacturing process does not include the step of fermentation. Therefore, the characteristic profile of green tea is different from that of black tea.

Green tea is known for its health benefits. As the green tea polyphenols are not oxidized due to the fermentation step, it is considered to deliver more catechins than black tea. Historically and traditionally green tea consumed mainly in China Japan and Korea. However, because of its health benefits, it is also now becoming popular in countries like India and also other parts of the world.

The organoleptic properties including the aroma profile of green tea is quite different to that of black tea because of the difference in processing. Floral notes in the aroma delivered from a green tea product is quite less as compared to that of a black tea.

There are prior arts which discloses green tea with enhanced aroma.

WO 2011/151237 (Unilever, 2011) discloses a process for preparation of green leaf tea comprising the steps of (a) taking a fresh tea leaf, (b) incubating the plucked leaf at a temperature in the range 10° C. to 40° C. under anaerobic conditions for a period of 4-36 hours; (c) drying the incubated tea leaf to a moisture content less than 10% by total mass of the tea leaf to obtain the green leaf tea; where the tea leaf is not exposed to aerobic conditions between the steps (b) and (c) for a period greater than 60 minutes, and there is no step of steaming or pan firing during the process.

We have found that the process disclosed by the above prior art can further be improved to provide higher floral aroma.

Therefore, there is a need to provide a green tea product with enhanced floral notes.

The present inventors while working on the above problem have surprisingly found that a green tea manufacturing process that comprises a step of anaerobic incubation followed by pan firing or steaming produces a green tea with higher floral notes. Further to the surprise the present inventors have found that the present process leads to a tea product which delivers higher soluble tea solids at the end cup.

### SUMMARY OF THE INVENTION

Accordingly, in a first aspect there is provided a process of preparation of green leaf tea product comprising the steps of:
a. incubating fresh tea leaf at a temperature in the range 4° C. to 80° C. under anaerobic conditions for a period of 4 to 72 hours;
b. subjecting the incubated leaf to a step of thermal treatment at a temperature in the range of 60° C. to 250° C. for about 15 seconds to 60 minutes;
c. drying the incubated tea leaf to a moisture content less than 8% by total mass of the tea leaf to obtain a green leaf tea
wherein step (b) is carried out by pan firing or steaming.

In a second aspect the present invention provides a tea product wherein the ratio of geraniol to t-2-hexenal is greater than 20.

These and other aspects, features and advantages will become apparent to those of ordinary skill in the art from a reading of the following detailed description. For the avoidance of doubt, any feature of one aspect of the present invention may be utilized in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

“Tea” for the purposes of the present invention means material from Camellia sinensis var. sinensis and/or Camellia sinensis var. assamica. Especially preferred is material from var. assamica as this has a higher level of tea actives than var. sinensis.

“Leaf tea” for the purposes of this invention means a tea product that contains tea leaves and/or stem in an uninfused form, and that has been dried to a moisture content of less than 30% by weight, and usually has a water content in the range 1 to 10% by weight (i.e. “made tea”).

“Fresh tea leaf” refers to tea leaf, buds and/or stem that have never been dried to a water content of less than 30% by weight, and usually have moisture content in the range 60 to 90%.

“Fermentation” refers to the oxidative and hydrolytic process that tea undergoes when certain endogenous enzymes and substrates are brought together, e.g. by mechanical disruption of the cells by maceration of the leaves. During this process, colourless catechins in the leaves are converted to a complex mixture of yellow and orange to dark-brown polyphenolic substances.

“Black tea” refers to substantially fermented tea. Black tea has different characteristics to green tea. Black tea is more astringent in taste and less bitter than green tea. The redness of black tea liquor is also significantly higher than that of green tea. Black tea also contains higher level of theaflavins.

“Green tea” refers to substantially unfermented tea. Green tea has different characteristics than black tea. Green tea liquor is light in colour unlike black tea. Green tea also enriched with catechins and low or no amount of theaflavins.

The present invention provides a process of preparation of green leaf tea product comprising the steps of:
a. incubating fresh tea leaf at a temperature in the range 4° C. to 80° C. under anaerobic conditions for a period of 4 to 72 hours;
b. subjecting the incubated leaf to a step of thermal treatment at a temperature in the range of 60° C. to 250° C. for about 15 seconds to 60 minutes; and
c. drying the leaf to a moisture content less than 8% by total mass of the tea leaf to obtain a green leaf tea.
wherein step (b) is carried out by pan firing or steaming.

### Step (a):

Step (a) includes incubating fresh tea leaf at a temperature in the range 4° C. to 80° C. under anaerobic conditions for a period of 4 to 72 hours. The term “anaerobic conditions” as used herein means that the gas phase in contact with the leaf has less than 3%, preferably less than 2% and more preferably less than 1% oxygen by volume. It is particularly preferred that the gas phase in contact with the leaf is substantially free of oxygen.

The fresh leaf may be selected as two leaves and a bud, three leaves and a bud, or more than three leaves and a bud. The duration of time between plucking the fresh tea leaf and the incubation is preferably less than 24 hours, more preferably less than 12 hours and most preferably less than 8 hours. However, it is possible that the duration of time between plucking the fresh tea leaf and the incubation is longer than 24 hours if the tea leaf is stored at temperature of less than 15° C.

### Anaerobic Conditions:

The anaerobic conditions are optionally achieved by:
i. placing the fresh tea leaf in a container, and closing the container, or;
ii. placing the tea leaf in a container, purging a gas essentially free of oxygen through the container, and closing the container, or placing the leaf in an airtight chamber or under vacuum.

Preferably, the anaerobic conditions are achieved by: placing the fresh tea leaf in a container, and closing the container, or placing the tea leaf in a container, purging a gas essentially free of oxygen through the container through the container, and closing the container.

By placing the fresh leaf in a container and closing the container, the oxygen concentration in the gas phase decreases with time and anaerobic conditions are achieved after keeping the container closed for a certain amount of time. The container is closed for a duration of preferably greater than 3 hours, more preferably greater than 4 hours and most preferably greater than 6 hours or even greater than 8 hours.

Alternatively, and more preferably, the anaerobic conditions are achieved by placing the leaf in a container, purging a gas essentially free of oxygen through the container and closing the container. The gas other than oxygen is preferably nitrogen or carbon dioxide, most preferably nitrogen.

Once the container is closed in step i or ii above, there is no particular restriction as to the pressure in the container. The pressure inside the closed container is preferably from 1.33×10² Pa to 1.33×10⁵ Pa, more preferably 1.33×10³ Pa to 1.06×10⁵ Pa and most preferably 2.67×10³ Pa mm Hg.

It is preferred that the moisture loss from the leaf during the step is as low as possible. This is advantageously and conveniently achieved by carrying out this step under closed conditions. The incubated tea leaf after this step preferably comprises water in the range of from 70 to 75% by weight.

### Incubation Temperature:

Step (a) is at a temperature in the range 4° C. to 80° C., preferably in the range 4° C. to 65° C., more preferably in the range 10° C. to 50° C.

### Duration of Anaerobic Incubation:

The time of incubation is in the range of 4 to 72 hours, preferably 4 to 50 hours, more preferably 6 to 30 hours and most preferably 8 to 20 hours.

Preferably the incubated tea leaves are not exposed to aerobic condition after step (a) and before step (b) for more than 60 minutes, preferably 50 minutes, more preferably 30 minutes, furthermore preferably 20 minutes, even more preferably 10 minutes and most preferably 5 minutes.

### Step (b):

In this step, the incubated leaf is subjected to a step of heat treatment at a temperature in the range of 60° C. to 250° C. for about 15 seconds to 60 minutes.

The preferred temperature of the heat treatment is in the range of 70° C. to 150° C., more preferably 80° C. to 150° C., furthermore preferably 90° C. to 150° C., even more preferably 100° C. to 150° C. and most preferably 120° C. to 150° C.

The preferred time of heat treatment step is in the range of 30 seconds to 50 minutes, more preferably 1 to 30 minutes, furthermore preferably 2 to 15 minutes, even more preferably 2 to 10 minutes and more preferably 3 to 8 minutes.

The step of heat treatment is carried out by pan firing and/or steaming.

The moisture content of the tea leaf after this step preferably in the range of 60% to 85% by weight. Preferably for steaming process the moisture content is in the range of 70% to 85% by weight whereas for pan firing the moisture content preferably is the range of 65% to 75% by weight.

Preferably there is no step of comminution of tea leaf prior to step (b).

Further preferably there is no step extraction of tea leaf prior to step (b).

### Step (c):

After the step of thermal treatment, the leaf undergoes drying. The moisture content of the leaf after drying is less than 8%, preferably less than 7%, more preferably less than 6% and most preferably less than 5% by weight of the leaf.

The drying step is preferably carried out by thermal drying, freeze drying or vacuum drying.

Thermal drying is preferably carried out by contacting the leaf with air; with the temperature of air being preferably 80 to 160° C., more preferably 90 to 150° C., most preferably 100 to 130° C. Thermal drying may be carried out in any conventional dryer. However, a fluidized bed dryer or a tray dryer is particularly preferred for thermal drying. The leaf can also be dried by vacuum drying. During vacuum drying the tea leaf is subjected to an absolute pressure of preferably from 66.7 to 6.67×10⁴ Pa, more preferably from 6.67×10³ to 3.9×10⁴ Pa and most preferably from 1.3×10⁴ to 2.67×10⁴ Pa. Vacuum drying is carried out at a temperature in the range of preferably 20 to 70° C., more preferably 25 to 60° C. and most preferably 30 to 55° C. Vacuum drying may be carried out in any suitable vacuum drier, preferably in a rotary vacuum drier.

### Optional Steps:

After step (b), the tea leaves are preferably subjected to a step of comminution (size reduction) to produce dhool.

This step of size reduction is preferably carried out by crushing, tearing and curling (known in the art of tea processing as CTC). One or more CTC steps may be carried out. In this step the incubated leaf breaks up and releases enzymes that exist in the leaf.

Alternatively, after the incubation step, the incubated tea leaf is rolled in an orthodox roller or comminuted in a rotorvane, or a combination thereof. During these steps, precursors present in the tea leaf become amenable to the enzymes.

Optionally there is an additional step of subjecting the comminuted dhool to a step of shear. Preferably the dhool is subjected to shear for 30 seconds to 15 minutes by passing the dhool through an instrument with shear rate in the range of 5000/s to 25000/s.

The term ‘shear’ preferably means the act of producing strain in the structure of a substance/material. Shear as mentioned herein preferably means damaging the comminuted dhool in a controlled way wherein the residence time of the dhool in the shear producing instrument is relative high compared to maceration in a CTC machine. The direction of application of force and the stress transfer preferably to be perpendicular to each other.

Preferably, the shear is produced by passing the dhool through an instrument. This is preferably done by using a mechanical device. The preferred mechanical devices are screw press, plough shear mixer etc.

The dhool is exposed to shear preferably for 30 seconds to 5 minutes and most preferably 30 seconds to 3 minutes.

The shear rate for the above step is preferably in the range of 10000/s to 15000/s.

The shear is the rate at which a material deforms at a given speed in a channel having a defined depth and diameter. In case of the present disclosure, if the comminuted dhool (either at the pre-fermentation or post fermentation stage) is subjected to shear in a device with a shaft diameter D cm and with a channel depth of H cm of at N rpm, then the shear rate is:

$$Shear Rate = \frac{π * D * N}{H}$$

For the equipments for which the above equation is applicable, there is a rotating shaft inside a channel through which the material is to be passed. The rotation of this shaft conveys the material from one end (inlet) of the instrument to the other end (outlet). During this conveyance the material experiences shear as against the wall of the channel and the shaft. When the shaft is preferably having screw like extensions, it is known as screw press. Channel depth means the longitudinal distance from the shaft to the wall of the channel.

E.g. for a screw press wherein the diameter is 12.7 cm with a channel depth of 0.1 cm and at 25 rpm, the shear rate as calculated using the above equation is approximately 10000/s.

Preferably, pressure applied for the process is in the range of 10⁴ to 10⁶ Pa, more preferably 10⁴ to 5×10⁵ Pa, furthermore preferably 10⁴ to 2×10⁵ Pa and most preferably 10⁴ to 5×10⁴ Pa.

Preferably, the filling percentage of the dhool in said instrument is also considered as a controlling parameter. The words “filling percentage” preferably means the percentage of the instrument's available volume (i.e. capacity) that is filled by the dhool. Preferably the filling percentage of the dhool in said instrument is in the range of 35% to 80%, more preferably 40% to 80%, furthermore preferably 50% to 80% and most preferably from 60% to 80%.

The present invention also provides a tea infusion prepared by mixing 2 parts of green tea leaf product as obtained/obtainable by the process of the present invention as disclosed above with 50 parts of water with temperature in the range of 70° C. to 100° C. wherein the ratio of geraniol to t-2-hexenal is greater than 20. Preferably the ratio of geraniol to t-2-hexenal is greater than 22, more preferably greater than 25 and most preferably greater than 28.

### EXAMPLES

### Preparation of Different Tea Products

All the experiments were carried out in Turkey using tea leaf obtained from a tea garden in Turkey.

### Example A

Fresh tea leaves were plucked. After that the plucked tea leaves were dried in a fluidized bed drier (FBD) at 120° C. for about 15 minutes. The dried leaves were then comminuted using a rotorvane.

### Example B

Fresh tea leaves were plucked. After that the plucked tea leaves were incubated anaerobically by putting the leaves in a hermetically sealed container for 24 hours at 25° C. After that the plucked tea leaves were dried in a fluidized bed drier (FBD) at 120° C. for about 15 minutes. The dried leaves were then comminuted using a rotorvane.

### Example C

Fresh tea leaves were plucked. After that the plucked tea leaves were subjected to steaming at by passing steam at a temperature of 120° C. for about 3 min to inactivate enzymes. The steamed leaves were then dried in a fluidized bed drier (FBD) at 120° C. for about 15 minutes. The dried leaves were then comminuted using a rotorvane.

### Example 1

Fresh tea leaves were plucked. After that the plucked tea leaves were incubated anaerobically by putting the leaves in a hermetically sealed container for 24 hours at 25° C. Post that the incubated leaves were subjected to steaming at by passing steam at a temperature of 120° C. for about 3 min to inactivate enzymes. The steamed leaves were then dried in a fluidized bed drier (FBD) at 120° C. for about 15 minutes. The dried leaves were then comminuted using a rotorvane.

Tea infusions were prepared using the different tea products as described, by using the following protocol:

Tea infusions were prepared by infusing 2 g of prepared tea leaf in 200 mL of deionized hot water (˜90° C.) for 2 minutes and then it was filtered using a strainer.

The above prepared infusions were used for soluble solids content by using the protocol as described below.

### Determination of Soluble Solids of the Infusions:

The infusions (100 mL each) were taken into previously weighed aluminium pans in duplicates and evaporated to dryness. It was then kept in a hot air oven for 5 hours. The pans were transferred and cooled to room temperature in a vacuum desiccator followed by gravimetric measurements. The soluble solids were determined by differentiation in the weight of the plates.

### Determination of the Aroma Profile of the Infusions:

For determination of aroma profile tea infusion was prepared by infusing 2 g of above prepared tea leaf in 50 mL of de-ionized water (˜90 C) for 2 min and then it was filtered using strainer for volatiles measurements.

Gas chromatography (GC) was used to characterize the aroma profile of the aroma condensate obtained above.

5 mL (each) of the infusions as prepared above was taken for analysis in a capped GC vial containing 4 grams of NaCl. Aroma was measured in the headspace using a SPME fibre after the samples were pre-incubated (10 min) and then kept at 70° C. for 20 min. The conditions for gas chromatography and aroma extraction by SPME (solid phase micro extraction) are given below.

### GC-FID Conditions:

Volatile compounds from aroma condensate were analysed using a gas chromatograph with a FID detector (Perkin Elmer auto System XL). A CP-wax 52 CB (30 m×0.25 mm, film thickness 0.15 μm) column was used for analysis. The injector was operated at a split ratio of 1:5 with helium as the carrier gas at a constant flow rate of 1.0 mL/min. The injector was maintained at 230° C. The detector temperature was maintained at 250° C. The oven temperature was set at 45° C. throughout the experiment.

### SPME Conditions:

Analysis of volatile compounds released from the aroma condensate was carried out using SPME. More particularly, a 2 cm stable flex fiber, coated with 50/30 μm poly(divinylbenzene) (DVB)/carboxen (CAR)/poly(dimethylsiloxane) (PDMS) (Supelco, Bellefonte, Pa.) was used with automated SPME system (Combi PAL system).

### Equipment Specifications and Experimental Conditions:

SPME Fiber: Grey fiber (PDMS/DVB/CAR)
Pre-Incubation time: 10:00 min
Incubation temp: 70° C.

### Needle Penetration: 10 mm

### Fiber Penetration: 20 mm

### Extraction Time: 20:00 min

Desorb to: GC Injector port 1

### Injection Time: 5:00 min

Post fiber Condition time: 15 min
GC Run time: 50 min
Cooling time: 10 min
Fiber conditioning temp: 230° C.

The peak area is calculated for the individual volatile compounds from the GC chromatograms. Standard concentration curves are generated for each volatile. These standard curves are used to convert the peak area to a concentration for the respective volatiles.

The results of these experiments are summarized below in Table 1:

TABLE 1

| | Examples | | | |
|---|---|---|---|---|
| Parameters | A | B | C | 1 |

Floral notes signature molecules

| | | | | |
|---|---|---|---|---|
| Phenyl acetaldehyde (μg/50 mL) | 0.2 | 0.6 | 1.4 | 3.3 |
| Geraniol (μg/50 mL) | 0.9 | 3.6 | 6.3 | 18.3 |

Green notes signature molecules

| | | | | |
|---|---|---|---|---|
| Cis-3-hexenol (μg/50 mL) | 0.9 | 1.2 | 3.5 | 3.1 |
| t-2-hexenal (μg/50 mL) | 0.3 | 0.2 | 0.9 | 0.6 |
| Ratio of geraniol to Cis-3- | 1 | 3 | 1.8 | 5.9 |
| hexenol | | | | |
| Ratio of geraniol to t-2-hexenol | 3 | 18 | 7 | 30.50 |
| Soluble solids (mg/100 mL) | 194 | 198 | 220 | 248 |

From the above table it is evident that Example 1 (within the scope of the present invention) provides a green tea with higher floral aroma when compared with Examples A to C (outside the scope of present invention). It is also noted that the present invention also provides a green tea product with higher delivery of soluble solids.

1. A method of preparing a green leaf tea product comprising the steps of:
a. incubating fresh tea leaf at a temperature in the range 10° C. to 80° C. under anaerobic conditions for a period of 4 to 72 hours;
b. subjecting the incubated leaf to a step of thermal treatment at a temperature in the range of 60° C. to 250° C. for about 2 to 10 minutes;
c. drying the leaf to a moisture content less than 8% by total mass of the tea leaf to obtain the green leaf tea.
wherein:
the step (b) is carried out by pan firing or steaming; and
the fresh tea leaf is from Camelia sinensis.

2. The method as claimed in claim 1 wherein there is no step of comminution of tea leaf prior to the step (b).

3. The method as claimed in claim 1 wherein there is no step extraction of tea leaf prior to the step (b).

4. The method as claimed in claim 1 wherein the step (c) is carried out either by thermal drying, freeze drying, or vacuum drying.

5. The method as claimed in claim 1 wherein the step (b) is carried out at a temperature in the range of 70° C. to 150° C.

6. The method as claimed in claim 1 further comprising subjecting the incubated leaf to shear before the step (b).

7. The method as claimed in claim 6 wherein the incubated leaf is exposed to the shear for about 30 seconds to 15 minutes.

8. The method as claimed in claim 6 wherein the shear is provided at a shear rate in the range of 5000/s to 25000/s.

9. The method as claimed in claim 6 wherein the pressure applied to produce the shear is in the range of 0.1 to 10 bars.

10. The method as claimed in claim 6 wherein the shear is generated using a mechanical device.

11. The method as claimed in claim 1 wherein the anaerobic conditions are achieved by:
i. placing the fresh tea leaf in a container and closing the container;
ii. placing the fresh tea leaf in a container, purging a gas essentially free of oxygen through the container, and closing the container; or
iii. placing the fresh tea leaf in an airtight chamber or under vacuum.

12. The method as claimed in claim 11 wherein the anaerobic conditions are achieved by placing the fresh tea leaf in a container and closing the container.
